(19) United States
(12) Patent Application Publication
(10) Pub. No.: US 2023/0058308 A1
(43) Pub. Date: Feb. 23, 2023

(54) MULTILAYER COMPOSITE COMPRISING A BACKBONE FILM

(71) Applicant: DSM IP ASSETS B.V., Heerlen (NL)

(72) Inventor: Brian RULE, Echt (NL)

(21) Appl. No.: 17/785,789

(22) PCT Filed: Dec. 21, 2020
(86) PCT No.: PCT/EP2020/087440

§ 371 Date: Jun. 15, 2022

Related U.S. Application Data
(60) Provisional application No. 62/951,301, filed on Dec. 20, 2019.

(51) Int. Cl. B32B 5/12; B32B 5/02; B32B 7/03; B32B 27/08; B32B 27/40; B32B 37/20

(52) U.S. Cl. CPC B32B 5/12; B32B 5/022; B32B 5/024; B32B 7/03; B32B 27/08; B32B 27/40; B32B 37/203; B32B 2250/03; B32B 2307/518; B32B 2375/00; B32B 2367/00; B32B 2250/24; B32B 2260/021; B32B 2260/046; B32B 2262/0253; B32B 2305/18; B32B 2307/7265; B32B 2323/04

(57) ABSTRACT

The present invention relates to a multilayer composite comprising a first monolayer comprising high-performance fibers, aligned in a first direction and a first matrix material and a second monolayer comprising high-performance fibers, aligned in a second direction and a second matrix material and a third polymeric film located in between the first and the second monolayer, with the third polymeric film having a tensile modulus of at least 0.75 GPa measured by ASTM D882. Preferably the high-performance fibers comprise UHMWPE fibers. A thermoplastic polyurethane is in contact with the first monolayer to form a first outer layer of the composite and in contact with the second monolayer to form a second outer layer of the composite, opposite to the first outer layer. The present invention further relates to the use of the multilayer composite in backpacks, packs, bags, medical gear, outdoor products, sail cloths, tents, tarps, shelters, clothing, ponchos, foul weather gear, mats, outerwear, jackets, sleeping bags, lift bags, parachutes, large kites, inflatable structures, beams, balloons, backraft, inflatable gear, liferaft, inflatable sculptures, airship (HAA: High Altitude Airships), space applications, flexible circuits, footwear and umbrella's.

The present invention relates to a multilayer composite comprising: a first monolayer comprising high-performance fibers, aligned in a first direction and a first matrix material and a second monolayer comprising high-performance fibers, aligned in a second direction and a second matrix material. The present invention also relates to the use of the multilayer composite in different applications.

Multilayer composites comprising a first monolayer comprising high-performance fibers, aligned in a first direction in a first matrix material and a second monolayer comprising high-performance fibers, aligned in a second direction in a second matrix material are known in the art. In for example US2016023428 such multilayer composites are disclosed. Moreover these composites may comprise an outer layer at both sides of the composite. This outer layer can be a film such as a polyurethane film. A disadvantage of these multilayer composites comprising the polyurethane outer film is that a significantly low tensile strength and shear performance is provided in comparison to what one would expect for the specific amount of fiber reinforcement in the composites.

It is therefore an object of the present invention to provide a lightweight multilayer composite with improved mechanical properties.

It is a further object to the present invention to provide a lightweight multilayer composite with improved tensile strength.

It is a further object to the present invention to provide a lightweight multilayer composite with improved shear strength.

The object of the present invention has been achieved in that a multilayer composite is comprises: a first monolayer comprising high-performance fibers, aligned in a first direction and a first matrix material and a second monolayer comprising high-performance fibers, aligned in a second direction and a second matrix material and an inner polymeric film located in between the first and the second monolayer, wherein the inner polymeric film having a tensile modulus of at least 0.75 GPa measured by ASTM D882.

Surprisingly it has been found that the inner polymeric film which is located in between the first and the second monolayer provides a multilayer composite with improved tensile strength. This is surprising because the tensile load of the composite is carried primarily by the high-performance fibers, and the increase in tensile strength exceeds the tensile strength contribution of the inner polymeric film. Moreover, it has been found that the multilayer composite comprising the inner polymeric film show an improved lap shear seam strength. Is has further been found that the inner polymeric film may improve the load sharing properties of the multilayer composite. This film essentially creates a “backbone” for the composite, and despite fragility/low strength of the “backbone film”, the resulting composite material achieves a higher strength than a material without “backbone”.

The inner polymeric film has a tensile modulus of at least 0.75 GPa measured by ASTM D882. Preferably the inner polymeric film has a tensile modulus 2 GPa. More preferably it has a tensile modulus of at least 4 GPa, even more preferably a tensile modulus of at least 6 GPa.

The inner polymeric film or backbone film is preferably chosen from the group consisting of a polyester film, polyethylene film, polyamide film or polyvinyl fluoride film. Preferably the inner film is chosen from a polyester film. More preferably the polyester is chosen from polyethylene terephthalate (PET) or polyethylene naphtalate (PEN). The inner polymeric film preferably has a thickness from 1 μm to 100 μm, preferably from 2-50 μm, more preferably form 3-40 μm.

The inner polymeric film or backbone film may be in the form of a woven or non-woven fabric. Preferably the inner film is in the form of a non-woven fabric. The non-woven fabric preferably comprises at least one of carbon fibers, polyethylene fibers, polyamide fibers or polyester fibers or mixtures thereof. The non-woven fabric more preferably comprises carbon fibers as these fibers add stiffness to the multilayer composite.

In another embodiment the inner film may be a waterproof and/or (non)-breathable film.

In a further preferred embodiment, the inner polymeric film may be a waterproof/breathable (W/B) film. The W/B film functions as a barrier layer that permits the transfer of gas, including water vapor, through the materials but not the transfer of liquid water. Such films include ECTFE and EPTFE branded as Gore-Tex® and eVent®, polyamide, polyester, PVF, PEN, specially engineered with UHMWPE membranes, such as for example Solupor® membrane, and microporous polypropylene membranes.

A special embodiment of W/B film in the present invention may be in the form of a woven fabric, such fabric may be coated or (partially) impregnated with a matrix material to allow for its W/B properties.

Another special embodiment of the W/B film in the present invention may be in the form of a non-woven fabric, such fabric may be coated or (partially) impregnated with a matrix material to allow for its W/B properties. A typical example of a non-woven fabric includes a felt.

The first and second monolayers of the multilayer composite of the present invention comprises high-performance fibers, whereby the first layer comprises high-performance fibers, aligned in a parallel direction in a first matrix material and a second layer comprises high-performance fibers, aligned in a parallel direction in a second matrix material. The second fiber direction is preferably offset relative to the first fiber direction by up to 90 degrees. The high-performance fiber(s) in the first and second layer may be the same or different.

The first and second monolayers may also be referred to as a unidirectional (UD) layers. The multilayer composite may include one or more additional monolayers bonded thereon forming a stack of layers. In this way, many monolayers may be used and the fiber direction may never be repeated, or several monolayers may be offset from each other until at some point the fiber direction in a layer repeats with a monolayer further below in the stack.

The first and second matrix material may be chosen from polyacrylates, polyurethanes such as Hysol US0028, polyesters such as thiokol Adcote, silicones such as DOW-96-083, -X3-6930, -6858 (UV curable), polyolefins, modified polyolefines, ethylene copolymers such as ethylene vinyl acetate, polyamide, polypropylene or thermoplastics such as PEEK, PPS, Radel, Ryton.

Preferably, the matrix material comprises a polyurethane. The polyurethane may comprise a polyether-urethane or a polyester-urethane based on a polyetherdiol. The polyurethane is preferably based on aliphatic diisocyanates because this further improves product performance.

In a further preferred embodiment, the matrix material may comprise an acrylic based resin, or a polymer comprising acrylate groups.

In case of a polyolefin, the matrix material preferably comprises a homopolymer or copolymer of ethylene and/or propylene, wherein the polymeric resin has a density as measured according to IS01183 in the range from 860 to 930 kg/m³, a peak melting temperature in the range from 40° to 140° C. and a heat of fusion of at least 5 J/g.

Further details of matrix materials and monolayers with unidirectional fibers may be found in for example U.S. Pat. No. 5,470,632, incorporated herein by reference in its entirety.

The amount of matrix material in the first or second monolayer is typically between 10 and 95 wt %; preferably between 20 and 90 wt %, more preferably between 30 and 85 wt %, and most preferably between 35 and 80 wt %. This ensures adequate bond strength between the monolayer(s) and other components, thereby reducing the chance for premature delamination in the composite after repeated flexural cycles.

The high-performance fibers used in the first and second monolayers typically have a tensile strength of at least 0.5 GPa, preferably at least 0.6 GPa, more preferably at least 0.8 GPa. In a preferred embodiment the strength of the fibers, preferably polyethylene fibers, is at least 3.0 GPa, preferably at least 3.5 GPa, more preferably at least 4.0 GPa and most preferably at least 4.5 GPa. For economic reasons, the strength of the fibers is preferably less than 5.5 GPa. The fibers preferably have a tensile strength of between 3.1 and 4.9 GPa, more preferably between 3.2 and 4.7 GPa, and most preferably between 3.3 and 4.5 GPa.

The amount of fiber in a monolayer is generally between 1 and 50 grams per square meter. The amount of fiber may also be referred to as the fiber density of a layer. Preferably the amount of fiber in one monolayer is between 2 and 30 grams per square meter, more preferably between 3 and 20 grams per square meter. It has been found that fiber densities in these ranges help to maintain flexibility of the multilayer composite material.

Suitable fibers for use in the multilayer composite material according to the invention include, for example, fibers based on polyamides, such as polyamide 6 or polyamide 6.6, polyesters, such as polyethylene terephthalate or polyolefins such as polypropylene or polyethylene. Other preferred fibers include aromatic polyamide fibers (also often referred to as aramid fibers), especially poly(p-phenylene teraphthalamide); liquid crystalline polymer and ladder-like polymer fibers such as polybenzimidazoles or polybenzoxazoles, such as poly(1,4-phenylene-2,6-benzobisoxazole) (PBO), or poly(2,6-diimidazo[4,5-b-4′,5′-e]pyridinylene-1,4-(2,5-dihydroxy)phenylene) (PIPD; also referred to as M5); polyaryl ether ketones including polyether ether ketone and fibers of, for example, polyolefins, polyvinyl alcohol, and polyacrylonitrile which are highly oriented, such as obtained, for example, by a gel spinning process. Highly oriented polyolefin, aramid, PBO and PIPD fibers or a combination of at least two thereof are preferably used. Highly oriented polyolefin fibers include polypropylene or polyethylene fibers and have a tensile strength of at least 1.5 GPa.

Most preferred are high performance polyethylene fibers, also referred to as highly drawn or oriented polyethylene fibers consisting of polyethylene filaments that have been prepared by a gel spinning process, such as described in for example GB 2042414 A or WO 01/73173. The advantage of these fibers is that they have very high tensile strength combined with a light weight, so that they are suitable for use in extremely thin layers. Preferably, use is made of fibers of ultra-high molar weight polyethylene (UHMWPE) with an intrinsic viscosity of at least 4 dl/g, more preferably an intrinsic viscosity of at least 8 dl/g.

In various embodiments, the multilayer composite comprising the first and second monolayers and optionally other monolayers may further comprise at least a first and second polymeric film in contact with the first and second monolayer such as to form the outer layers of the multi-layer composite. In this way, a stack of a first, second monolayer and inner polymeric film comprises the core of the multilayer composite and the first and second polymeric films are exposed as the two outer layers.

The first and second polymeric film may comprise, for example, a polyolefin film, such as a linear low-density polyethylene, a polypropylene film, a polyurethane film or a polyester film. The first and second polymeric film may be the same film or different. Preferably the first and second polymeric film are polyurethane films.

In a more preferred embodiment, the first and second outer polymeric films are biaxial stretched polyolefin or polyester films. Examples hereof are biaxial stretched high-density polyethylene films, biaxial stretched polypropylene films or biaxial stretched PET or PEN film.

The present invention also relates to a process for the manufacturing of the multilayer composite by stacking the at least a first monolayer comprising parallel aligned fibers and a first matrix material and a second monolayer comprising parallel aligned fibers and a second matrix material and an inner polymeric film in between the first and second monolayer, the assembly having two outer surfaces comprising a first and second polymeric film whereby the assembly is compressed at an absolute pressure of between 1.05 and 5 bar, preferably at an absolute pressure of between 1.1 and 4 bar, more preferably at an absolute pressure of between 1.2 and 3 bar. Compressing under these conditions is accomplished in a static press, including an autoclave. Preferably a continuous press is used in the form of a calendar or a continuous belt press. The temperature during compression is preferably between 35° and 120° C. More preferably the temperature during pressing is between 40 and 100° C. and most preferably the temperature during pressing is between 45 and 90° C. compressed at a pressure between 1 and 5 bar, and temperature between 35 and 120° C. The time of pressure and temperature treatment varies by the intended end use and can be optimized via simple trial and error experiments.

In a special version of the process to manufacture the multilayered composite material at least one of both first and second polymeric film surfaces of the composite is in contact with, preferably a removable, cover during the pressure and temperature treatment. The cover may be a fiberglass reinforced PTFE sheet, or may be a steel belt, in e.g. a continuous belt press, optionally with a release layer e.g. in the form of a siliconized paper. An alternative form of such a removable cover comprises a soft material based on rubber. The Shore A value of the rubber is less than 95, more preferably less than 80 and preferably at least 50, as determined by Durometer test per ISO 7619. Chris please review this section, is this section relevant here?

The first and second monolayers may be obtained by orienting a plurality of fibers in parallel fashion in one plane, for instance by pulling a number of fibers or yarns from a fiber bobbin frame over a comb and impregnating the fibers with the matrix material in a way known to the skilled person, before, during or after orienting. In this process, the fibers may have been provided with a finish with at least one component or polymer other than the plastic matrix material in order to, for instance, protect the fibers during handling or in order to obtain better adhesion of the fibers onto the plastic of the monolayer. The fibers may have been surface treated before finishing or before contacting the fibers with the matrix material. Such treatment may include treatment with chemical agents such as oxidizing or etching agents, but preferably includes plasma or corona treatment.

For further fine tuning the properties of the multilayer composite material, one may decide to add a third monolayer and subsequent monolayers, up to n monolayers, in contact with and rotated relative to an adjacent monolayer to offset the fiber directions. In various embodiments, the total number of monolayers, n, may be between about 4 and about 8, (4<n<8). Depending on the application, the value of n may be chosen to suit the particular application or end use. In the multilayer composite material according to the invention, each monolayer may be rotated relative to a previous monolayer.

The present invention further relates to the use of the multilayer composite according to the present invention in backpacks, packs, bags, medical gear, outdoor products, sail cloths, tents, tarps, shelters, clothing, ponchos, foul weather gear, mats, outerwear, jackets, sleeping bags, lift bags, parachutes, large kites, inflatable structures, beams, balloons, backraft, inflatable gear, liferaft, inflatable sculptures, airship (HAA: High Altitude Airships), space applications, flexible circuits, footwear, inflatables (radomes), tension structures or umbrella's.

### RESULTS

### Methods of Measuring

The following are test methods as referred to herein:

Tensile strength is measured according to ASTM D3039 in which a strip of material of a uniform, measured width is gripped in a top and bottom bollard grip and pulled in tension at a rate of 3 inch/min until failure

Tensile modulus of polymeric films is measured by ASTM D882, as reported by film suppliers.

Film thickness identified by film supplier and is measured by handheld digital micrometer.

Laminate weight is measured following ASTM D3776-07 by weighing a 12 by 12 inch laminate sample using an analytical balance with display precision to 0.0001 grams. Laminate weight is reported in terms of grams per square meter (gsm).

### EXAMPLES

A composite laminate is manufactured comprising a first monolayer comprising high performance fibers (ultra-high molecular weight polyethylene (UHMWPE)) in a polyurethane (PUR) matrix oriented in a 0° direction and a second monolayer comprising UHMWPE fibers in a PUR matrix oriented in a 90° direction with an inner polymeric film in between the first and second monolayer of high performance fibers, further optionally comprising a first outer polymeric film on top laminate surface and an identical second polymeric film on the bottom laminate surface. The composite is cut into target 1 inch width strips and 26 inches length, with the length running parallel to the 0° direction. The actual width of each sample is measured and recorded. Each lengthwise end of the sample is gripped by bollard style grips, with a resulting gage length of the test sample of 10 inches. The sample is pre-tensioned to 5% of the expected laminate failure load by a mechanical test frame. The sample is tested for tensile strength at a constant rate of extension of 3 inches/minute until sample failure. The maximum tensile load of the sample during the duration of the test is recorded and divided by the width of the sample to determine a tensile strength in terms of Load/Width.

From table 1 it is clear that there is a balance between the inner polymeric film thickness, weight, and modulus.
In table 2 comparatives are presented; multilayer composites without inner or backbone film.

TABLE 1

| | First and | | | | Inner | | | | |
|---|---|---|---|---|---|---|---|---|---|
| | second | | | | Film | | | % Increase | % |
| First and | monolayer | | | | Thickness | Mean | | TSTensile | Increase |
| second | with fiber | UHMW | | Inner Film | in mil | Tensile | Laminate | Strength vs | Weight |
| outer film | orientation | PE Fiber | Inner | Modulus | (1 mil = 25. | Strength | Weight | Standard (no | vs |
| | degrees | Type | film | (GPa) | 4 μm) | (lbf/in) | (gsm) | backbone) | Standard |
| 1.TPU/TPU | 0/90 | SK75 | PEN | 12.2 | 0.08 | 191.63 | 119.92 | 2.74 | 2.29 |
| 2.TPU/TPU | 0/90 | 2640 | PEN | 12.2 | 0.16 | 237.10 | 122.60 | 27.12 | 4.57 |
| 3.TPU/TPU | 0/90 | dtex | PEN | 12.2 | 0.24 | 254.03 | 125.27 | 36.19 | 6.85 |
| 4.TPU/TPU | 0/90 | | PET | 4.5 | 0.18 | 222.48 | 123.52 | 19.28 | 5.36 |
| 5.TPU/TPU | 0/90 | | Perforated | 4.5 | 0.18 | 223.17 | 123.52 | 19.65 | 5.36 |
| | | | PET | | | | | | |
| 6.TPU/TPU | 0/90 | | Tedlar | 2.6 | 1.5 | 252.47 | 172.44 | 35.36 | 47.08 |
| 7.N/A | 0/90 | SK99 | PET | 4.5 | 0.18 | 689.10 | 73.95 | 28.04 | 9.27 |
| | | dtex | | | | | | | |
| 8.N/A | 0/90 | 880 | PET | 4.5 | 0.18 | 661.10 | 73.95 | 22.83 | 9.27 |

TPU= thermoplastic polyurethane
PEN= polyethylene naphtalate
PET= polyethylene terephthalate
Tedlar= polyvinylfluoride

TABLE 2
Comparative experiments

| | First | | | | | Mean | |
|---|---|---|---|---|---|---|---|
| | and | Fiber | | | | Tensile | Laminate |
| | second | reinforcem | UHMWPE | | Inner | Strength | Weight |
| | Film | orientation | Fiber Type | Matrix | film | (lbf/in) | (gsm) |
| I | TPU/ | 0/90 | SK75 2640 | PUR | None | 186.52 | 117.24 |
| | TPU | | dtex | | | | |
| II | N/A | 0/90 | SK99 880 | PUR | None | 538.21 | 67.68 |
| | | | dtex | | | | |

1. A multilayer composite comprising:
a first monolayer comprising high-performance fibers, aligned in a first direction and a first matrix material and
a second monolayer comprising high-performance fibers, aligned in a second direction and a second matrix material and
an inner polymeric film located in between the first and the second monolayer, with the inner polymeric film having a tensile modulus of at least 0.75 GPa measured by ASTM D882.

2. Multilayer composite according to claim 1 wherein the second fiber direction is offset relative to the first fiber direction by up to 90 degrees.

3. Multilayer composite according to claim 1 wherein the high-performance fibers comprise polyethylene fibers.

4. Multilayer composite according to claim 3 wherein the high-performance fibers comprise UHMWPE fibers.

5. Multilayer composite according to claim 1, wherein the inner polymeric film has a thickness from 1 μm-100 μm.

6. Multilayer composite according to claim 1 wherein the inner polymeric film is chosen from the group consisting of a polyester, polyethylene, polyamide or polyvinyl fluoride.

7. Multilayer composite according to claim 6 wherein the inner polymeric film is chosen from polyethylene terephthalate (PET), polybutylene terephthalate (PBT) or polyethylene naphtalate (PEN).

8. Multilayer composite according to claim 1 wherein the inner polymeric film is in the form of a woven or non-woven fabric.

9. Multilayer composite according to claim 1 wherein the inner polymeric film is a waterproof and/or (non)-breathable film.

10. A multilayer composite according to claim 1 wherein at least one matrix material is chosen form the group of polyacrylates, polyurethanes, polyesters, silicones, polyolefins, modified polyolefins, ethylene copolymers, polyamide, polypropylene.

11. A multilayer composite according to claim 10 wherein the first and second matrix material comprise polyurethane.

12. Multilayer composite according to claim 1 wherein the first monolayer optionally comprises a first polymeric film and the second monolayer optionally comprises a second polymeric film.

13. Multilayer composite according to claim 12 wherein the first polymeric film is in contact with the first monolayer to form a first outer layer of the composite and wherein the second polymeric film is in contact with the second monolayer to form a second outer layer of the composite, opposite to the first outer layer.

14. Multilayer composite according to claim 12 wherein the first and second polymeric film is chosen from polyurethane.

15. Use of the multilayer composite of claim 1 in backpacks, packs, bags, medical gear, outdoor products, sail cloths, tents, tarps, shelters, clothing, ponchos, foul weather gear, mats, outerwear, jackets, sleeping bags, lift bags, parachutes, large kites, inflatable structures, beams, balloons, backraft, inflatable gear, liferaft, inflatable sculptures, airship (HAA: High Altitude Airships), space applications, flexible circuits, footwear, sports apparel, luggage; leather goods, jackets, wallets, purses, upholstery, gloves.
